(19) United States
(12) Patent Application Publication
(10) Pub. No.: US 2019/0205700 A1
(43) Pub. Date: Jul. 4, 2019

(54) MULTISCALE ANALYSIS OF AREAS OF INTEREST IN AN IMAGE

(71) Applicant: Uber Technologies, Inc., San Francisco, CA (US)

(72) Inventor: Lionel Gueguen, Erie, CO (US)

(21) Appl. No.: 15/885,735

(22) Filed: Jan. 31, 2018

Related U.S. Application Data
(60) Provisional application No. 62/612,235, filed on Dec. 29, 2017.

(51) Int. Cl. G06K 9/62; G06T 3/40; G06T 7/11; G06T 7/174; G06K 9/20; G06K 9/34

(52) U.S. Cl. CPC G06K 9/6257; G06T 3/40; G06T 7/11; G06T 7/174; G06T 2207/20084; G06K 9/344; G06T 2207/20016; G06T 2207/20081; G06K 9/2054

(57) ABSTRACT

A system identifies areas of interest (e.g., locations of text or objects) in an image in a way that reduces memory requirements, computer processing requirements, and computation time. The system analyzes a downscaled version of an input image using a convolutional neural network that has been trained to recognize areas of interest in coarse, low resolution, images. Based on the output of the coarse neural network, the system predicts particular segments of the image that are most likely to include areas of interest. A second convolutional neural network that has been trained to identify areas of interest in fine, high resolution images analyzes only those segments of the image that the coarse neural network selected for further examination. A reconstruction of the analysis locates likely areas of interest for the whole image.

### CROSS REFERENCE TO RELATED APPLICATIONS

This application claims the benefit of U.S. Provisional Application No. 62/612,235 filed Dec. 29, 2017, which is incorporated by reference herein.

### BACKGROUND

### Field of Art

This disclosure relates generally to image processing, and in particular to reducing computation time when detecting areas of interest in an image.

### Description of Art

Images photographed at street level can be used for mapping and navigation. For example, it may be useful for identification, mapping, and navigation purposes to know locations of traffic lights, road signs, business signs, street numbers, and other objects in a landscape. Unfortunately, existing techniques for analyzing images for areas of interest can be slow, and can take up large amounts of memory space and computing resources. This is especially the case for large, high-resolution images. At the same time, high-resolution images are often useful for identifying areas of interest in an image because they include more detail.

### SUMMARY

An image analysis method identifies areas of interest in images significantly faster than previously, while maintaining a detection accuracy that is comparable to previous techniques. The method includes multiscale analysis of image segments. Specifically, an image is divided into segments. The image segments are analyzed by a sequence of convolutional neural networks, where each subsequent neural network is trained to analyze image segments at a finer resolution.

The image is downscaled and each segment is analyzed by a “coarse” neural network that is trained to identify potential areas of interest in a coarse, low-resolution image. The coarse neural network identifies segments that potentially include areas of interest, and segments that are unlikely to contain areas of interest.

Finer resolution versions of only the image segments that were identified by the coarse neural network as likely to contain areas of interest are analyzed by a “fine” neural network, which is trained to analyze image segments at finer resolution for likely areas of interest. The results of the fine image analysis are combined with analysis from the coarse neural network such that likely areas of interest for the complete image are identified. The method is not limited to two convolutional neural networks, but may include image segment analysis by any number of neural networks, each subsequent network trained to identify areas of interest in images of finer resolution.

### BRIEF DESCRIPTION OF THE DRAWINGS

FIG. 1 illustrates a high-level box diagram of a system architecture for an image processing system, according to an embodiment.

FIG. 2 illustrates a process for training neural networks to detect areas of interest at high and low resolutions, according to an embodiment.

FIG. 3 illustrates a process for detecting areas of interest in an image using neural networks, according to an embodiment.

FIG. 4 is a high level flow chart that describes a process for determining segments of an image that are likely to contain areas of interest, according to an embodiment.

FIG. 5 is a block diagram illustrating components of an example machine able to read instructions from a machine-readable medium and execute the instructions in one or more processors, in accordance with an embodiment.

The figures depict an embodiment of the invention for purposes of illustration only. One skilled in the art will readily recognize from the following description that alternative embodiments of the structures and methods illustrated herein may be employed without departing from the principles of the invention described herein.

### DETAILED DESCRIPTION

Analysis of street-level and satellite imagery is often used for mapping and navigation purposes. In particular, image analysis techniques are useful for automatically detecting text and other areas of interest in images. For example, the ability to automatically detect business text, street numbers, and road signs enables more complex and automatic mapping techniques.

However, it currently takes a large amount of time, computing power, and memory space to analyze the images. This is particularly true for large data sets of high-resolution images, for example, some data sets include billions of images for analysis, each of which may have millions or billions of pixels. Applying current technologies to an individual image can take several minutes to analyze a single 4k×4k image.

To reduce processing requirements and speed up the process of image analysis while maintaining the accuracy of the results, a computer model analyzes an image to identify segments of interest with lower processing requirements and subsequently analyzes those segments of interest in more detail. The system divides the image into logical segments (e.g., quadrants). A downscaled version of the complete original image is then analyzed by a convolutional neural network (CNN) that has been trained to identify likely areas of interest in coarse, that is low resolution, images. Based on the analysis of the coarse CNN on the downscaled image, the system selects logical segments of the image that are most likely to be of interest.

For each segment of the downscaled image that was selected as being likely to contain an area of interest, the system analyzes the corresponding segment of the original image using a CNN that has been trained to identify likely areas of interest in fine, that is high resolution, images. The output values of the analysis of the segment by the fine CNN are combined with an up-scaled version of the output values of the logical segment as was analyzed by the course CNN. The system uses the combined output values to determine a fine scale prediction of likely areas of interest within the image segment.

The system combines the text likelihood predictions for each of the logical image segments into a single data set that represents likely areas of interest throughout the whole image. In most cases, the image analysis is significantly faster and less computationally intensive than it would have been using existing image analysis processes because only segments of the image that are most likely to contain areas of interest are analyzed at a high resolution.

For simplicity, this document describes a system with two stages of analysis, that is, the coarse CNN and the fine CNN. However, in other embodiments, the system can be extended to a multiscale analysis with an arbitrary number of scales of analysis. For example, the system could be extended to three scales of analysis: coarse, medium, and fine. In that case, a CNN trained to analyze coarse images would determine which image segments should be analyzed at a medium scale. A CNN trained to analyze medium scaled images would determine which of those segments should be analyzed at a fine scale, and those identified segments would be analyzed by a CNN trained to analyze fine scaled images.

Furthermore, this document occasionally references text detection. Text detection is one example of detecting areas of interest in an image, but the method described herein is not limited to text detection. Rather, the image analysis may be applied to detect whatever type of areas of interest that the CNNs are trained to identify.

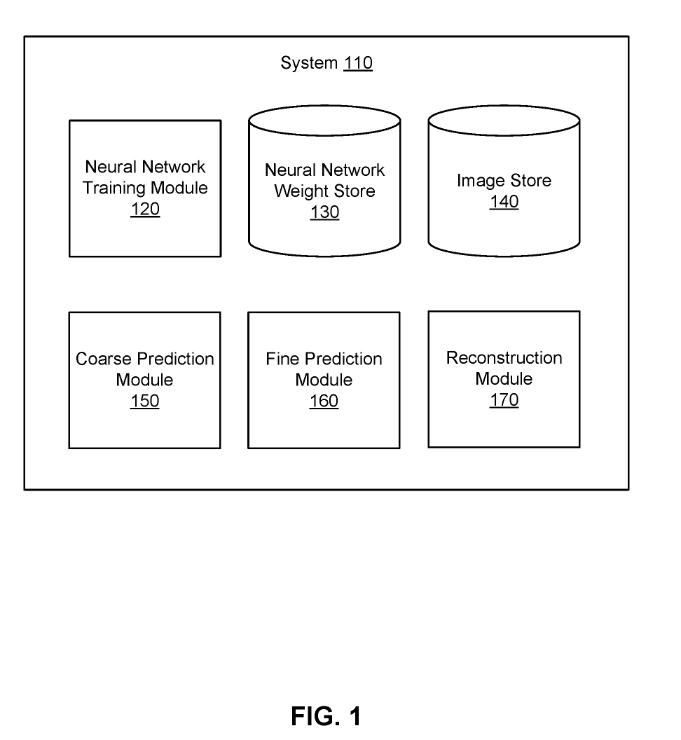

FIG. 1 illustrates a high-level box diagram of a system architecture for an image processing system, according to an embodiment. The system 110 includes a neural network training module 120, a neural network weight store 130, an image store 140, a coarse prediction module 150, a fine prediction module 160, and a reconstruction module 170. The functions performed by the various entities of FIG. 1 may vary in different embodiments. The system 110 may contain more, fewer, or different components than those shown in FIG. 1 and the functionality of the components as described herein may be distributed differently from the description herein. For example, as was previously indicated, in various embodiments the system 110 may have a different number of prediction modules, depending on how many scales of analysis are used. Additionally, the system 110 may be connected to other systems and client devices via a network, in some embodiments.

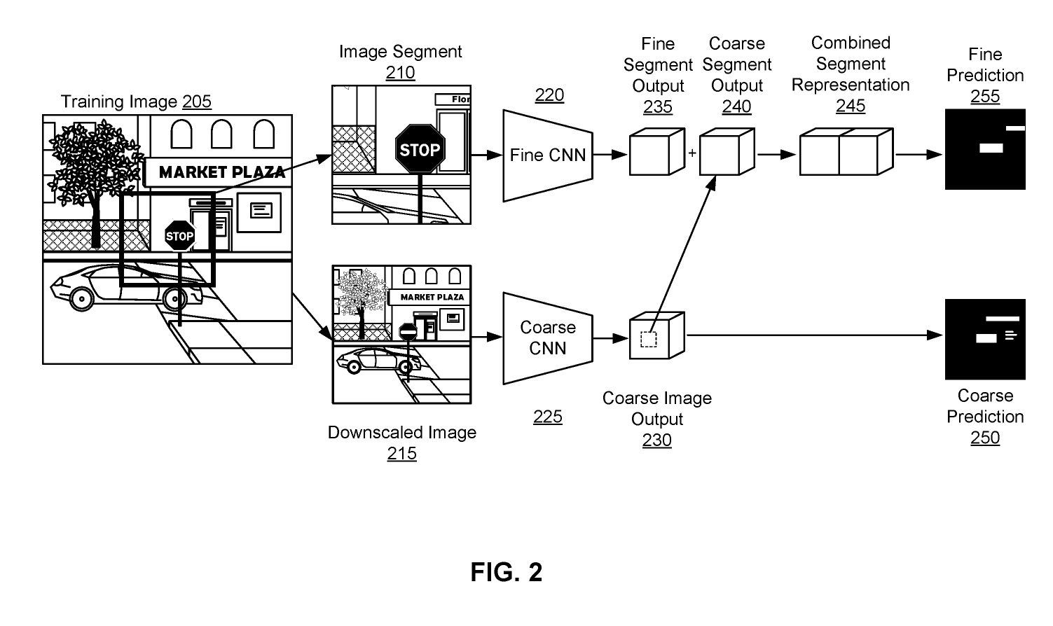

The neural network training module 120 trains CNNs to analyze images at various scales of analysis. The neural network training module 120 may use labeled training images and image masks to develop weights for the CNNs. To train a CNN, its current weight values may be used to analyze a training image. The neural network training module 120 compares output of the analysis to labeled image mask values and adjusts the weights based on the difference between the two. As a CNN is provided with additional training images, the weight values are further adjusted and improved. More detail about training the neural networks is provided in the description of FIG. 2.

The neural network weight store 130 stores the weights generated by the neural network training module 120. The neural network weight store 130 may also store information about the neural network architectures. The system 110 may employ neural network architectures that downscale spatially, such as ResNet or VGG architectures. When the system 110 needs to use a CNN for analyzing coarse images, it uses the appropriate weight values from the neural network weight store 130 for analyzing image data.

The image store 140 stores images for the system 110. The images in the image store 140 may include training images and images for analysis. Training images may include images of various sizes and resolutions which are labeled, for example, with an indication of whether the image contains areas of interest, where the areas of interest are located within the image, and general identifications of what is depicted in each area of interest. Training images stored in the image store 140 may also include masks of images that can be compared to masks produced by a CNN. An image mask is a representation of an image in which each area of the image (e.g., each pixel) is represented by either a 0 value or a 1 value (or another non-zero value). For example, an image mask for an image may include pixels with a value of 1 over areas of interest in the image and pixels with a value of 0 everywhere else in the image. Thus, a mask may be a designation in a training image of which portions of the image are supposed to be identified as interesting by the neural networks. In different embodiments, the masks may have various resolutions, including a per-pixel resolution. Images for analysis as stored in the image store 140 may include images awaiting analysis, intermediate stages of image analysis (e.g., downscaled images and image segments), and masks of images identifying areas of interest.

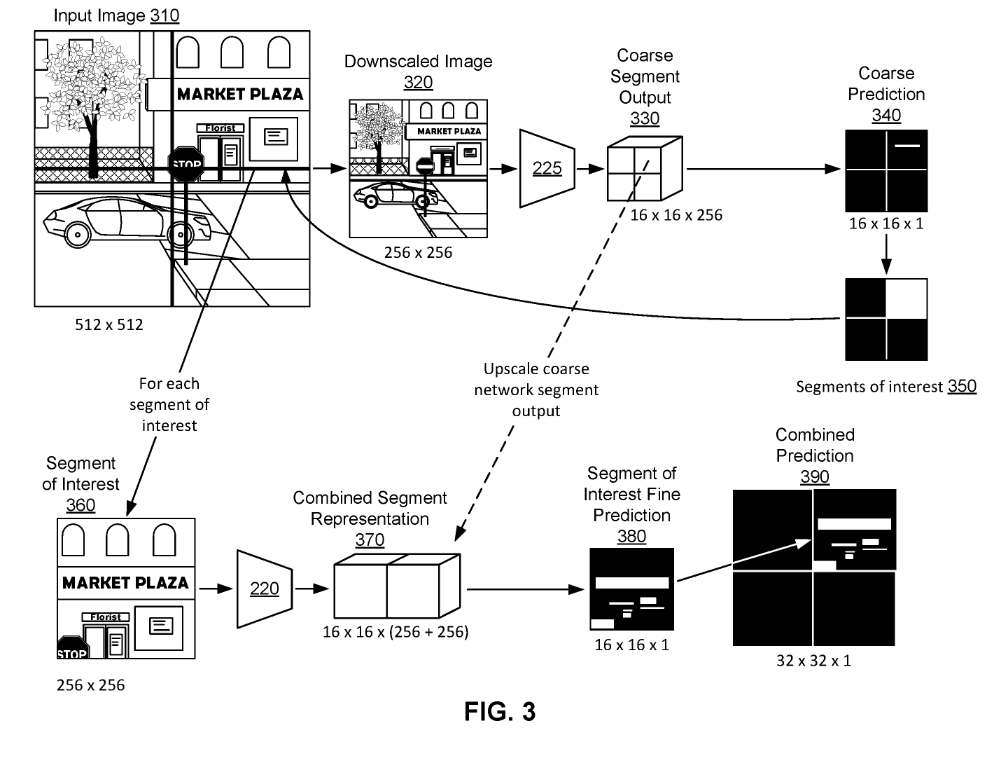

The coarse prediction module 150 divides an image into segments (e.g., quadrants), downscales the original image, and analyzes the coarse (e.g., downscaled) version of the image. The coarse prediction module 150 accesses weights for a coarse CNN from the neural network weight store 130. The coarse CNN is used to analyze each of the image segments of the downscaled image. The coarse prediction module 150 determines which of the image segments are likely to contain areas of interest. A prediction generated by the coarse prediction module 150 may take the form of a mask of an image segment with values representing whether areas of the image segment are likely to be of interest. In some embodiments, the values representing areas of an image segment may be used by the coarse prediction module 150 to determine whether the image segment should be further analyzed. For example, a system administrator or machine model may specify an attention threshold value against which a maximum predicted value may be compared to determine whether a fine CNN should analyze that image segment. Coarse prediction and the coarse prediction module 150 are discussed at greater length in the description of FIG. 3.

The fine prediction module 160 analyzes image segments at a fine scale (e.g., at a higher resolution) to determine whether the image segments contain areas of interest. Specifically, the fine prediction module 160 analyzes the image segments that the coarse prediction module 150 identified as having a likelihood of containing areas of interest. The image segments analyzed by the fine prediction module 160, although corresponding to the same segments as identified by the coarse prediction module 150, are analyzed at a higher resolution. In other words, in this embodiment the image segments analyzed by the fine prediction module 160 are not downscaled, or are less downscaled than the image segments analyzed by the coarse prediction module 150. The fine prediction module 160 identifies likely areas of interest in the image segments. In some embodiments, the fine prediction module 160 combines outputs from the fine CNN and the coarse CNN when reducing image segment data to a prediction about likely areas of interest. Fine prediction and the fine prediction module 160 are discussed at greater length in the description of FIG. 3.

In some embodiments, a reconstruction module 170 reconstructs a representation of an entire image after image segments have been analyzed. An image representation is a set of values that indicate areas of interest in different portions of the image (e.g., a mask of the entire image). To reconstruct a representation of likely areas of interest in an image, the reconstruction module 170 stitches together the analysis of all of the image segments.

In some cases, an area of interest may overlap multiple image segments. For example, if the system 110 is detecting text in an image, characters from a large word may be present in adjacent image segments. The reconstruction module 170 may identify adjacent areas of interest from neighboring image segments as being related to each other, in one embodiment.

In some embodiments, the reconstruction module also performs object detection, optical character recognition (OCR), or the like, on identified areas of interest in a reconstructed image. Thus, after determining likelihoods that certain areas of an image depict particular objects or text, the reconstruction module 170 may determine what is interesting in the image (e.g., by identifying text, traffic lights, etc.). This may be done using additional neural networking, machine learning, and OCR techniques.

FIG. 2 illustrates a process for training neural networks to detect areas of interest at high and low resolutions, according to an embodiment. The CNNs may be trained on a dataset of training images 205 stored in the image store 140. The image store 140 may store training images 205 of various sizes and resolutions. Training images 205 are associated with masks, that act as labeled validation data for the training process. Training images 205 may also or alternatively include other labels (e.g., metadata) that indicate whether an image includes an area of interest, and that may also identify what is depicted in the area of interest, or the location of the area of interest within the image. In some embodiments, training image 205 labels may depend on the particular type of area of interest that a CNN is being trained to classify. For example, when training a neural network to identify text in an image segment, a training image 205 may be labeled as either including text or not including text, and a mask may designate the location of the text in the training image.

To train the CNNs, a downscaled image 215 of a training image 205 is provided to the coarse CNN 255 and an image segment 210 of the training image 205 is provided to the fine CNN 220. The fine CNN 220 produces values for a fine segment output 235 by applying its current set of weights to the image segment 210. For example, output may be in the form of multiple matrices of values. Similarly, the coarse CNN 225 produces values for a coarse image output 230 by applying its own current set of weights to the downscaled image 215.

To produce a coarse prediction 250 of areas of interest in the training image 205, a convolution is applied to reduce multiple layers of output value matrices in the coarse image output 230 into a single layer of output (e.g., a mask), referred to herein as a coarse prediction 250. Specifically, the output of the coarse CNN 225 can be a set of values for each location in an image, for example, wherein each value in a set is obtained from a different filter or convolution that is applied to a location of an image. For example, such a set of output values may be a multi-layered set of values corresponding to a given pixel in the downscaled image 215. A convolution may be used to convert a set of values into a single value to represent the location in the image in a mask of the coarse prediction 250.

To produce a fine prediction 255, the fine segment output 235 is combined with a coarse segment output 240 from the coarse image output 230. That is, the portion of the coarse image output 230 that corresponds to the image segment 210 is up-scaled to the size of the fine segment output 235. The coarse segment output 240 and fine segment output 235 are combined as a combined segment representation 245. The coarse segment output 240 can be sets of values for each location in a segment of the image, as determined by the coarse CNN 255 for a portion of the coarse image output 230. Similarly, the fine segment output 235 can be sets of values for each location of the image segment 210, as obtained from the fine CNN 220. The set of coarse values and the set of fine values may be combined for each location within the image segment 210. A convolution is applied to convert the multiple layers of output in the combined segment representation 245 into a fine prediction 255 (e.g., a mask).

To improve the weights of the fine CNN 220 and the coarse CNN 255, and thus to train the neural networks, the fine prediction 255 and the coarse prediction 250 may be compared to the labeled training image information. For example, the predictions may be compared to a mask of the training image 205, or compared to masks of the image segment 210 or the downscaled image 215. The weights and bias values of the fine CNN 220 and the coarse CNN are adjusted in view of how accurate the fine prediction 255 and coarse prediction 250 are based on the mask comparisons. Optimization algorithms that may be used for adjusting weights and bias values of the neural networks include gradient descent, stochastic gradient descent, and others.

The training process is repeated multiple times, with various different training images 205. The weights and biases of the fine CNN 220 and the coarse CNN 225 are adjusted with each analysis of a new training image 205. In some embodiments, the fine CNN 220 and the coarse CNN 225 can share the same weights, thus each performing the same analysis on their respective scaling of an image.

FIG. 3 illustrates a process for detecting areas of interest in an image using neural networks, according to an embodiment. An input image 310 is provided to the system 110 for analysis. In the example of FIG. 3, and for the sake of demonstrating how the analysis process may reduce the size of the image data, input image 310 is a 512 by 512 pixel square image. The input image 310 is first analyzed by the coarse prediction module 150. The coarse prediction module 150 segments the image. In the example of FIG. 3, the input image 310 is divided into quadrants of 256 by 256 pixels each.

The coarse prediction module 150 creates a downscaled image 320 that is a smaller version of the entire input image 310. The downscaled image 320 is provided as input to the coarse CNN 225. The coarse CNN 225 generates coarse segment output 330, comprising layers of output data, for example, in the form of matrices of output values (e.g., sets of values for each location in the image). In the example of FIG. 3, the coarse segment output 330 has been reduced to 256 layers of 16 by 16 pixel matrices, that is, 256 image locations, each with sets of 256 associated values. The coarse prediction module 150 applies a convolution to reduce the output layers of the coarse segment output 330 into a 16 pixel by 16 pixel coarse prediction 340 (e.g., a mask designating areas of interest in the image segment). In one embodiment, the convolution results in a matrix of values, each value corresponding to a pixel in a 16 by 16 pixel downscaled representation of the input image 310. Each such value may indicate a likelihood that the area of the image represented by the pixel is an area of interest. In one embodiment, the coarse prediction module 150 may have a learned or preprogrammed detection threshold value. If the likelihood value associated with a pixel is above the detection threshold value, the pixel is considered to represent an area of interest within the mask of the image.

Using the coarse prediction 340, the coarse prediction module 150 identifies segments of interest 350. A segment of interest 350 is a segment of the input image that the coarse prediction 340 predicts as having a likelihood of having areas of interest, and in particular, that should be further analyzed by the fine CNN 220. The coarse prediction module 150 divides the coarse prediction 340 into segments that correspond to the segments into which it divided the input image 310.

In one embodiment, the coarse prediction module 150 determines a response value for each segment of the coarse prediction 340. For example, the coarse prediction module may count the number of pixels of interest in each segment of the coarse prediction 340. In other embodiments, the coarse prediction module 150 may use another metric to determine whether a segment is a segment of interest 350. For example, the coarse prediction module 150 may determine a percentage of the segment that is identified as potentially interesting. The response value is a value identified by the coarse prediction module 150 by such a metric. To determine whether a segment is a segment of interest 350, the coarse prediction module 150 compares the response value of each segment to an attention threshold value. The attention threshold value may be learned or preprogrammed. If the response value of a segment is greater than the attention threshold value, the coarse prediction module 150 identifies the segment as a segment of interest 350.

After the coarse prediction module 150 has determined a set of segments of interest 350, the fine prediction module 160 retrieves full-sized copies of the segments of interest 360 from the input image 310. In the example of FIG. 3, a full-sized segment of interest 360 is 256 by 256 pixels.

The fine prediction module 160 analyzes each segment of interest 350 individually. The fine prediction module 160 provides a segment of interest to the fine CNN 220 for analysis. The fine CNN outputs multiple layers of output data matrices (e.g., multiple output values for each analyzed location within the segment of interest 360). For example, the fine CNN 220 of FIG. 3 outputs 256 layers of 16 by 16 matrices of analysis values after analyzing a segment of interest 360.

The fine prediction module 160 retrieves the output data that corresponds to the same segment of the input image 310 from the coarse segment output 330. The segment of coarse segment output 330 is up-scaled so that its matrices of output data are the same size as the output matrices in the output from the fine CNN 220. The fine prediction module 160 combines the segment output data from the coarse segment output 330 with the output data from the fine CNN 220, as is represented in FIG. 3 by a combined segment representation 370.

A convolution is applied to reduce the combined segment representation 370 to a single layer mask of the data, herein referred to as a segment of interest fine prediction 380. Like the coarse prediction module 150, the fine prediction module 160 may also use a detection threshold to determine whether data from the convoluted combined segment representation 370 should represent an area of interest in the segment of interest fine prediction 380. The fine prediction module 160 performs the above process for each segment of interest 350 that was identified by the coarse prediction module 150.

The reconstruction module 170 uses the output from the analyses of the coarse prediction module 150 and the fine prediction module 160 to create a combined prediction 390. The combined prediction is a representation of areas of interest for the entire input image 310. In one embodiment, the combined prediction 390 is created by recombining the fine predictions 380 for the segments of interest and identifying all other segments as not containing areas of interest. By generating the combined prediction 390, the reconstruction module 170 reconstructs areas of interest that span across multiple segments of the image.

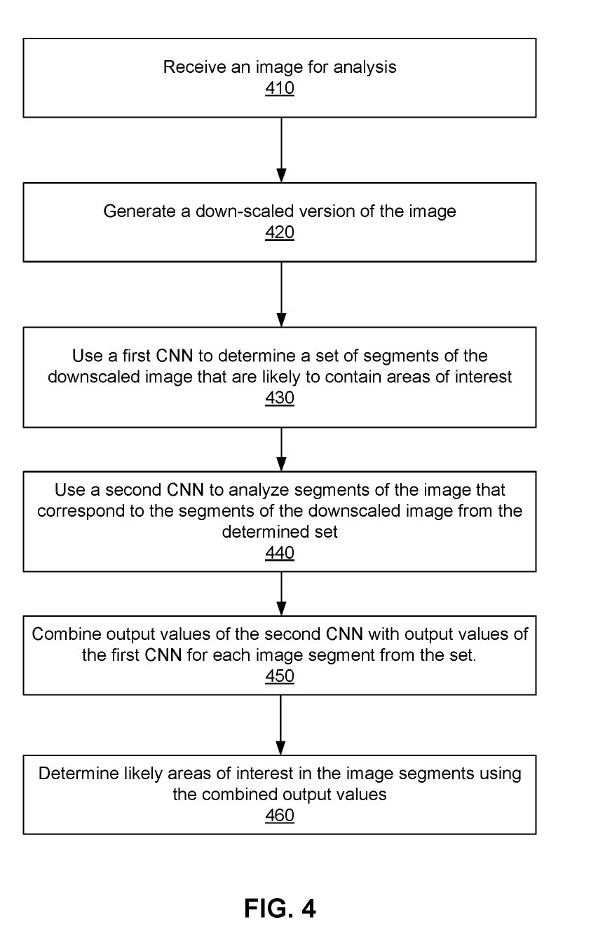

FIG. 4 is a high level flow chart that describes a process for determining segments of an image that are likely to contain areas of interest, according to an embodiment. The system 110 receives 410 an image for analysis. The system 110 generates 420 a down-scaled version of the image for analysis by the coarse prediction module 150. A first CNN is used 430 to determine a set of segments of the downscaled image that are likely to contain areas of interest. That is, a coarse CNN 225 is applied to the down-scaled image to determine segments of the image that are likely to contain areas of interest.

The system 110 uses 440 a second CNN to analyze segments of the image that correspond to the set of segments of the down-scaled image. The second CNN may be a fine CNN 220 that is trained identify areas of interest in higher resolution images than the coarse CNN 225 is trained to analyze.

Output from the analysis of the second CNN is combined 450 with output values of the first CNN for each segment from the set of segments that are analyzed by the second CNN. For example, the system 110 may combine an up-scaled version of a portion of matrices of output from the first CNN with the matrices of output from the second CNN for the corresponding image segment. Using the combined output values, the system 110 determines 460 likely areas of interest in the image segments. A reconstruction of final analyses of the image segments provides a representation of areas of interest for the complete image.

The described process of identifying interesting image segments and further analyzing those segments in more detail is beneficial because it can speed up image analysis, save memory space, and reduce computer processing requirements. In particular, the system 110 spends less time analyzing an image because it can analyze a downscaled image relatively quickly with a coarse CNN. Additional time, memory space, and processing power is only used to analyze image segments that are most likely to contain areas of interest with a fine CNN.

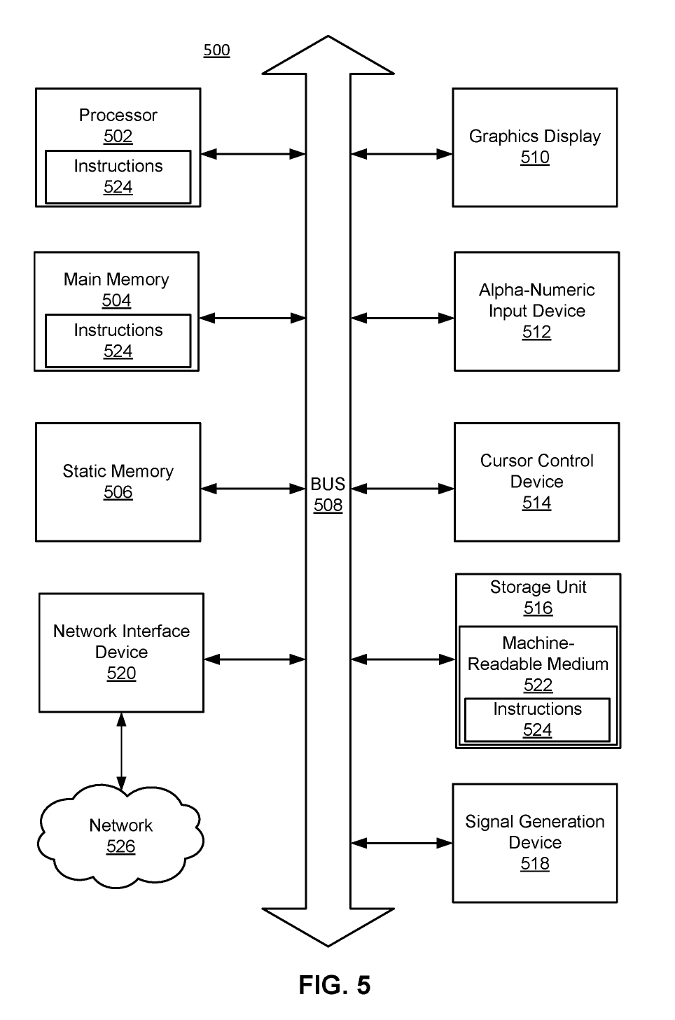

FIG. 5 is a block diagram illustrating components of an example machine able to read instructions from a machine-readable medium and execute them in one or more processors (or controllers). Specifically, FIG. 5 shows a diagrammatic representation of system 110 in the example form of a computer system 500. The computer system 500 can be used to execute instructions 524 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally processor 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 500 also includes a main memory 504. The computer system may include a storage unit 516. The processor 502, memory 504, and the storage unit 516 communicate via a bus 508.

In addition, the computer system 506 can include a static memory 506, a graphics display 510 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. For example, the instructions 524 may include instructions for implementing the functionalities of the neural network training module 120, the coarse prediction module 150, the fine prediction module 160 and/or the reconstruction module 170. The instructions 524 may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 may be transmitted or received over a network 526, such via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by one or more computer processors for performing any or all of the steps, operations, or processes described.

Embodiments may also relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. For instance, a computing device coupled to a data storage device storing the computer program can correspond to a special-purpose computing device. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
receiving an image for analysis;
generating a downscaled copy of the image;
using a first convolutional neural network (CNN) to analyze the downscaled copy of the image, determine a set of segments of the image that are likely to contain one or more areas of interest;
for each image segment in the determined set of image segments:
analyzing the image segment using a second CNN;
combining output values from the second CNN with up-scaled output values from the first CNN's analysis of the image segment from the downscaled image;
determining areas in the image segment that are likely to be of interest; and
combining the analyzed image segment data for all image segments.

2. The computer-implemented method of claim 1, further comprising:
training the first CNN using a training set of large images; and
training the second CNN using training data that includes downscaled segments of the large images.

3. The computer-implemented method of claim 1, wherein combining output values from the second CNN with up-scaled output values from the first CNN comprises:
accessing a portion of the output of the first CNN that represents the image segment, the portion of the output including a subset of matrices of output values;
up-scaling the portion of the output of the first CNN such that it is the same dimensions as matrices of output values from the second CNN; and
applying a convolution to the up-scaled portion of the output of the first CNN and the output values of the second CNN, the convolution reducing the data to a single matrix of values that are representative of likelihoods of areas of interest in the image segment.

4. The computer-implemented method of claim 1, wherein the same weighting values are used for the first CNN and the second CNN.

5. The computer-implemented method of claim 1, wherein an area of interest is a portion of an image that includes text.

6. The computer-implemented method of claim 1, wherein output values from a CNN include matrices of values, each matrix value associated with a portion of an input image.

7. The computer-implemented method of claim 1, wherein combining the analyzed image segment data for all image segments comprises constructing a representation of the whole image using image segment analysis data such that image segments from the determined set of image segments include indications of areas of interest within the image and such that image segments that were not in the determined set of image segments include no indication of any areas of interest.

8. A non-transitory computer-readable storage medium storing computer program instructions executable by one or more processors of a system to perform steps comprising:
receiving an image for analysis;
generating a downscaled copy of the image;
using a first convolutional neural network (CNN) to analyze the downscaled copy of the image, determine a set of segments of the image that are likely to contain one or more areas of interest;
for each image segment in the determined set of image segments:
analyzing the image segment using a second CNN;
combining output values from the second CNN with up-scaled output values from the first CNN's analysis of the image segment from the downscaled image;
determining areas in the image segment that are likely to be of interest; and
combining the analyzed image segment data for all image segments.

9. The non-transitory computer-readable storage medium of claim 8, wherein the instructions cause the one or more processors to perform further steps of:
training the first CNN using a training set of large images; and
training the second CNN using training data that includes downscaled segments of the large images.

10. The non-transitory computer-readable storage medium of claim 8, wherein combining output values from the second CNN with up-scaled output values from the first CNN comprises:
accessing a portion of the output of the first CNN that represents the image segment, the portion of the output including a subset of matrices of output values;
up-scaling the portion of the output of the first CNN such that it is the same dimensions as matrices of output values from the second CNN; and
applying a convolution to the up-scaled portion of the output of the first CNN and the output values of the second CNN, the convolution reducing the data to a single matrix of values that are representative of likelihoods of areas of interest in the image segment.

11. The non-transitory computer-readable storage medium of claim 8, wherein the same weighting values are used for the first CNN and the second CNN.

12. The non-transitory computer-readable storage medium of claim 8, wherein an area of interest is a portion of an image that includes text.

13. The non-transitory computer-readable storage medium of claim 8, wherein output values from a CNN include matrices of values, each matrix value associated with a portion of an input image.

14. The non-transitory computer-readable storage medium of claim 8, wherein combining the analyzed image segment data for all image segments comprises constructing a representation of the whole image using image segment analysis data such that image segments from the determined set of image segments include indications of areas of interest within the image and such that image segments that were not in the determined set of image segments include no indication of any areas of interest.

15. A computer system comprising:
one or more computer processors for executing computer program instructions; and
a non-transitory computer-readable storage medium storing instructions executable by the one or more computer processors to perform steps comprising:
receiving an image for analysis;
generating a downscaled copy of the image;
using a first convolutional neural network (CNN) to analyze the downscaled copy of the image, determine a set of segments of the image that are likely to contain one or more areas of interest;
for each image segment in the determined set of image segments:
analyzing the image segment using a second CNN;
combining output values from the second CNN with up-scaled output values from the first CNN's analysis of the image segment from the downscaled image;
determining areas in the image segment that are likely to be of interest; and
combining the analyzed image segment data for all image segments.

16. The computer system of claim 15, wherein the instructions are executable by the one or more processors to perform further steps of further comprising:
training the first CNN using a training set of large images; and
training the second CNN using training data that includes downscaled segments of the large images.

17. The computer system of claim 15, wherein combining output values from the second CNN with up-scaled output values from the first CNN comprises:
accessing a portion of the output of the first CNN that represents the image segment, the portion of the output including a subset of matrices of output values;
up-scaling the portion of the output of the first CNN such that it is the same dimensions as matrices of output values from the second CNN; and
applying a convolution to the up-scaled portion of the output of the first CNN and the output values of the second CNN, the convolution reducing the data to a single matrix of values that are representative of likelihoods of areas of interest in the image segment.

18. The computer system of claim 15, wherein an area of interest is a portion of an image that includes text.

19. The computer system of claim 15, wherein output values from a CNN include matrices of values, each matrix value associated with a portion of an input image.

20. The computer system of claim 15, wherein combining the analyzed image segment data for all image segments comprises constructing a representation of the whole image using image segment analysis data such that image segments from the determined set of image segments include indications of areas of interest within the image and such that image segments that were not in the determined set of image segments include no indication of any areas of interest.
